(19) United States
(12) Patent Application Publication
(10) Pub. No.: US 2003/0039383 A1
(43) Pub. Date: Feb. 27, 2003

(54) Flat field correction of two-dimensional biochemical assay images

(75) Inventors: Hamid R. Naghieh, Hayward, CA (US); Keith Kotchou, Walnut Creek, CA (US); Neeraj Bhatt, Fremont, CA (US); Jeffrey Gingrich, Alamo, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BIO-RAD LABORATORIES, INC., Hercules, CA

(21) Appl. No.: 10/174,510

(22) Filed: Jun. 17, 2002

Related U.S. Application Data
(60) Provisional application No. 60/301,343, filed on Jun. 26, 2001.

(51) Int. Cl. G06K 9/00

(52) U.S. Cl. 382/128; 382/129; 204/461; 204/612; 356/344

(57) ABSTRACT

The optical imaging of two-dimensional solute zone arrays in electrophoresis gels is corrected for nonuniformities in the optical system such as those arising from the light source or from light dispersion underneath the gel. The correction is achieved by the use of a reference plate that responds to a light source uniformly along its length and width by being either uniformly light absorptive or uniformly light transmissive, or by emitting light upon excitation. Thus, any nonuniformities or deviations in the image of the reference plate arise only from nonuniformities or deviations within the optical system. Analogous corrections are made in other two-dimensional assay images, such as microarrays and microtiter plates.

### CROSS-REFERENCE TO RELATED APPLICATIONS

This application claims the benefit of co-pending U.S. provisional patent application Ser. No. 60/301,343, filed Jun. 26, 2001, for all purposes legally served thereby. The contents of provisional patent application Ser. No. 60/301,343 are incorporated herein by reference in their entirety. All literature and patent references cited in this specification are likewise incorporated herein by reference in their entirety.

### BACKGROUND OF THE INVENTION

1. Field of the Invention

This invention resides in the technology of two-dimensional imaging systems such as those used in reading two-dimensional electrophoresis gels, and particularly to the problems encountered in optical systems that produce nonuniformities that are inherent in the light source and light dispersion that are part of these systems.

2. Description of the Prior Art

Fluorescent dyes, chemiluminescent labels and colorimetric labels as well as light absorption are used in two-dimensional electrophoresis gels to indicate the locations of solute zones. The identification and quantification of the individual proteins, nucleic acids, or other species that constitute the solutes are in many cases achieved by generating an electronic image. An example of a device that can form such an image is a charge coupled device, or CCD, which contains a two-dimensional array of pixels that convert incident light to a two-dimensional electronic array of electrical charge packets corresponding to the array of the zones. When nonuniformities exist in the optical system, the image will be distorted, and the accuracy of the results will be affected accordingly. Methods of correcting these nonuniformities are disclosed in U.S. Pat. Nos. 5,799,773 (issued Sep. 1, 1998), U.S. Pat. No. 5,891,314 (issued Apr. 6, 1999), U.S. Pat. No. 5,897,760 (issued Apr. 27, 1999), and U.S. Pat. No. 5,951,838 (issued Sep. 14, 1999) (all listing Heffelfinger, D. M., and C. Van Horn as inventors and assigned to Bio-Rad Laboratories, Inc.). The methods presented by these patents variously include calibrations of the lens and detector assemblies, using a scanning light source to achieve uniform illumination, using a mirror or beamsplitter to sample the source, or generating correction data over a range of aperture and magnification settings.

Certain nonuniformities arise from the light source and light dispersion underneath the gel, and it is these to which the present invention is specifically directed.

### BRIEF SUMMARY OF THE INVENTION

It has now been discovered that image irregularities due to nonuniformities in the light source and light dispersion beneath a two-dimensional electrophoresis gel can be corrected by comparing the image of the gel to the image of a reference plate that responds to incident light uniformly along its length and width. Thus, for example, the reference plate is uniformly absorptive and/or transmissive of light, or contains fluorescent material uniformly distributed throughout the plate and is uniformly excitable by incident light, as needed depending on the how the solute zones in the gel are imaged. The reference plate is placed in the imaging system independently of, i.e., in place of, the gel, and an image of the reference plate is taken in the same manner as the image of the gel. The two images are then compared, preferably on a pixel-by-pixel basis, and the gel image is corrected by an appropriate formula or algorithm that accounts for any non-uniformities or deviations in the reference plate image. The image of the reference plate may be termed a flat field image, and the corrected image of the gel may likewise be termed a flat field-corrected image.

Electrophoresis gels are an example of two-dimensional biochemical assays in general, and this invention extends to any biochemical assay whose results can be read as a two-dimensional image. Such an image includes optically detectable data that includes both a value indicative of intensity or magnitude and the location of said value in a two-dimensional plane. Examples of assay media other than electrophoresis gels from which such an image can be detected are microarrays and microtiter plates.

In certain embodiments of the invention, the images are arrays of fluorescent signals generated by excitation from an appropriate light source and detected by a CCD or other electronic detector, and the reference plate is a fluorescent reference plate placed between the light source and the detector. Fluorescent material is uniformly distributed throughout the reference plate and fluorescent light is therefore emitted by the entire reference plate upon excitation by the light source. Thus, in accordance with these embodiments of the invention, a uniformly fluorescent plate is placed in the position otherwise occupied by the gel, the light source is activated and an image of the plate is generated. The image is recorded and stored for use in correcting the electronic data representing the image of a gel.

### DETAILED DESCRIPTION OF THE INVENTION AND PREFERRED EMBODIMENTS

In embodiments of the invention in which the assay medium is a two-dimensional electroporesis slab gel, the assay results are an array of solute zones in the gel which have been separated by any of the various known methods of electrophoresis. The location of each zone serves as an indication of the identity of the solute occupying that zone, and in some cases the identity of the sample in which the solute was originally present, and the intensity of each zone serves as an indication of the amount or concentration of that solute in the original sample. The two-dimensional array may represent a series of parallel linear separations of different samples performed simultaneously in discrete lanes of the gel. Alternatively, the two-dimensional array may represent an array resulting from two-dimensional electrophoresis, i.e., a first stage linear separation followed by a second stage separation in a direction perpendicular to the first, thereby separating each zone formed in the first stage into further sub-zones. A still further alternative is a separation of a solute mixture by an oscillating or alternating electric field that alternates between two orthogonal directions.

In embodiments of the invention in which the assay medium is a microarray such as those used in nucleic acid microarray technology, the medium typically consists of a family of PCR (polymerase chain reaction) products spotted onto a polylysine coated microscope slide in a two-dimensional grid pattern. A typical assay protocol includes the hybridization of the nucleic acids on the slide with a target nucleic acids that has been extracted from a cell and labeled with a fluorescent label. Imaging and analysis of the slide for fluorescence then establishes which of the PCR products hybridizes to the target nucleic acid, identifying the PCR products by their location on the slide. Other variations are well known to those skilled in the art.

In embodiments of the invention in which the assay medium is a microtiter plate, individual assays are performed in each of the various wells of the plate, and the imaging and analysis of the medium establishes the results of each assay and identifies the results with the particular assay by virtue of the location of the well in which the assay was performed.

In each case, the reference plate is preferably a flat plate having the same dimensions as the assay medium or having at least the dimensions of the portion of the medium to be imaged. The thickness of the plate is not critical and may range from one-sixteenth inch (0.16 cm) to one-half inch (1.27 cm), although a preferred thickness is approximately one-eighth inch (0.32 cm). The reference plate responds to incident light uniformly along its length and width, i.e., the reference plate contains no nonuniformities itself that would cause it to either absorb or transmit light differently at any point on the plate than at any other point. In certain embodiments of the invention, the reference plate is a fluorescent reference plate of uniform thickness that transmits light without transmitting an image of the light source and is either colored with a fluorescent dye or white. The plate disperses the light striking it from the light source and emits the light toward the detector in a manner that includes no spatial variations other than those attributable to the light source. For systems in which the assay results are indicated by fluorescent labels and the image is generated by fluorescent signals from the assay medium, the reference plate has a fluorescent dye, such as a red or orange dye. For systems in which the assay results are generated by absorption of light from the light source rather than emission, one example of a suitable reference plate is a translucent fluorescent white that converts ultraviolet light from the light source to white light.

The imaging systems and reference plates used in the practice of this invention can be illuminated by any type of light source that is used or known to be capable of use in the imaging of two-dimensional electrophoresis gels. In many applications, imaging is done by UV light and accordingly UV light is a preferred light source.

The imaging of the gel and the imaging of the reference plate can be performed in any order. A preferred procedure however is to image the assay medium first and to image the reference plate after having imaged the assay medium. Applying this procedure to an electrophoresis gel, for example, the user first places the gel on the platen of the imaging system after the solute zones have been separated electrophoretically, and generates an image of the gel by transillumination or epi-illumination. The pattern of light transmission is thus detected and stored as digital data, although the data is not yet displayed. The user then removes the gel and cleans the platen, and places an appropriate reference plate on the platen in place of the gel. A reference image of the reference plate is then taken and stored as digital data. Data from this image are used to correct the data from the gel image. The corrected data are then displayed.

Correction of the data is achieved by any formula or algorithm that compares the two images and corrects the gel image on the basis of nonuniformities or deviations in the reference image. This comparison and correction are readily performed by software, which can then display the corrected image. For example, a preferred imaging process is one in which the images consist of two-dimensional arrays of pixels whose locations in the array are defined by orthogonal coordinates X and Y. The correction can then be performed for each pixel by software utilizing the known ratio equation:

$$Piff ( XY ) = Pi ( XY ) \times ( \frac{{Av}_{Flat}}{{P ( XY )}_{Flat}} )$$

in which:

Piff(XY) is the corrected value of the pixel at position XY

Pi(XY) is the value of the pixel at position XY before correction

Av_{Flat} is a coefficient obtained from the average of the values obtained with the reference plate, and

P(XY)_{Flat} is the value of the pixel at position XY of the reference plate.

The corrected pixels are then reassembled to form the corrected image. Other algorithms and methods of correction will be readily apparent to those skilled in the art.

An example of a gel imaging system to which this invention can be applied is the VersaDoc™ System of Bio-Rad Laboratories, Inc., Hercules, Calif., USA. The illumination can be either ultraviolet light or white light.

The foregoing is offered primarily for purposes of illustration. Those skilled in the art will recognize upon reading this specification that further variations, modifications, and substitutions can be made without departing from the spirit and scope of the invention.

What is claimed is:

1. A method for detecting optically detectable biochemical assay results in a two-dimensional biochemical assay medium, said method comprising the following steps:
(a) irradiating said assay medium with light from a light source in a two-dimensional optical imaging system to generate a two-dimensional image of said assay medium;
(b) irradiating a reference plate with light from said light source in said two-dimensional optical imaging system independently of said assay medium to generate a two-dimensional image of said reference plate, said reference plate being a plate that responds to incident light uniformly along the length and width of said reference it plate; and
(c) comparing said image of said assay medium to said image of said reference plate and correcting said image of said assay medium for nonuniformities in said optical imaging system indicated by said image of said reference plate: steps (a) and (b) being performed in any order and (c) performed after both (a) and (b) are completed.

2. A method in accordance with claim 1 in which said assay medium is an electrophoresis gel.

3. A method in accordance with claim 1 in which said assay medium is a microarray on a microscope slide.

4. A method in accordance with claim 1 in which said assay medium is a microtiter plate.

5. A method in accordance with claim 1 in which said reference plate is uniformly absorptive of light.

6. A method in accordance with claim 1 in which said reference plate is uniformly excitable by incident light to emit fluorescent light.

7. A method in accordance with claim 1 in which said incident light is from a UV light source.

8. A method in accordance with claim 1 in which said incident light is light from a white light source.

9. A method in accordance with claim 1 in which said biochemical assay is an assay whose results are indicated by assay reagents bearing fluorescent labels, said reference plate is a clear transparent plate containing a fluorescent dye, said incident light is from a light source that excites said fluorescent labels and said fluorescent dye to emit fluorescent light, and steps (a) and (b) comprise generating images of fluorescent signals.

10. A method in accordance with claim 1 in which said biochemical assay is an assay whose results are indicated by assay reagents bearing colorimetric labels absorptive of light at a selected wavelength, said reference plate is uniformly absorptive of light at said selected wavelength, and steps (a) and (b) comprise generating absorption images.

11. A method in accordance with claim 1 in which step (a) is performed before step (b).

12. A method in accordance with claim 1 in which said two-dimensional images of steps (a) and (b) consist of two-dimensional arrays of pixels whose positions in each said array are defined by orthogonal coordinates X and Y, each said pixel having a value detectable by said optical imaging system, and step (c) comprises correcting each pixel of said gel image of said gel according to the relation
$$Piff ( XY ) = Pi ( XY ) \times ( \frac{{Av}_{Flat}}{{P ( XY )}_{Flat}} )$$
in which:
Piff(XY) is the corrected value of the pixel at coordinates X and Y of said image of said gel,
Pi(XY) is the value of the pixel at coordinates X and Y of said image of said gel before correction,
Av_{Flat} is a coefficient equal to the average of the values of all pixels in said image of the reference plate, and
P(XY)_{Flat} is the value of the pixel at coordinates X and Y of said image of said reference plate.
